(19) United States
(12) Patent Application Publication
(10) Pub. No.: US 2026/0291189 A1
(43) Pub. Date: Sep. 24, 2026

(54) MULTIFUNCTIONAL INSULATOR CLEANING DEVICE

(71) Applicants: YUNNAN POWER GRID CO., LTD. TRANSMISSION BRANCH, Kunming (CN); YUNNAN ELECTRIC POWER TEST AND RESEARCH INSTITUTE (GROUP) CO., LTD, Kunming (CN)

(72) Inventors: Xuqiang GONG, Kunming (CN); Weiyan ZHAO, Kunming (CN); Kang CHEN, Kunming (CN); Liang YANG, Kunming (CN); Feng YANG, Kunming (CN); Zhengwen LI, Kunming (CN); Ruidong ZHENG, Kunming (CN); Zhangwang YANG, Kunming (CN); Ao CUI, Kunming (CN); Dapeng MA, Kunming (CN); Lichao JIANG, Kunming (CN); Hongbing CHEN, Kunming (CN); Guobin CANG, Kunming (CN); Zirui GAO, Kunming (CN); Hongwu WANG, Kunming (CN); Teng YANG, Kunming (CN); Xun SUN, Kunming (CN); Haishun LI, Kunming (CN); Fan WANG, Kunming (CN); Yang YE, Kunming (CN)

(73) Assignees: YUNNAN POWER GRID CO., LTD. TRANSMISSION BRANCH, Kunming (CN); YUNNAN ELECTRIC POWER TEST AND RESEARCH INSTITUTE (GROUP) CO., LTD, Kunming (CN)

(21) Appl. No.: 19/680,928

(22) Filed: May 18, 2026

Related U.S. Application Data
(63) Continuation of application No. PCT/CN2024/098798, filed on Jun. 12, 2024.

(30) Foreign Application Priority Data
Nov. 20, 2023 (CN) 202311540987.1

(51) Int. Cl. H02G 1/02; H01B 17/52

(52) U.S. Cl. CPC H02G 1/02; H01B 17/52

(57) ABSTRACT

A multifunctional insulator cleaning device includes: a cleaning component, a driving assembly, an adjustment component, and a triggering component, the cleaning component including the driving assembly, and two transmission assemblies symmetrically and slidably disposed at two ends of the driving assembly; abutment assemblies symmetrically fixed to the transmission assemblies; a cleaning assembly disposed at the abutment assemblies, the cleaning assembly being detachably insertable into the transmission assemblies, the driving assembly configured to drive the two transmission assemblies to operate, the two transmission assemblies configured to drive the cleaning assembly to rotate. When the two transmission assemblies move away from each other, the cleaning assembly is detachable from the transmission assemblies and the abutment assemblies.

### CROSS-REFERENCE TO RELATED APPLICATIONS

The present application is a continuation application of International Application No. PCT/CN2024/098798, filed on Jun. 12, 2024, which claims priority to Chinese Patent Application No. 202311540987.1, filed on Nov. 20, 2023, the entire contents of which are incorporated herein by reference.

### TECHNICAL FIELD

The present application relates to the technical field of insulator cleaning, and in particular to a multifunctional insulator cleaning device.

### BACKGROUND

High-voltage lines are important channels for power transmission, and ensuring the safety of power production is of great significance. In substations, the lines are exposed outdoors and are subject to long-term erosion by rainwater, which has a certain negative impact on power supply and, in severe cases, may affect the power supply of the entire line. In addition, long-term accumulation of dust and chemical substances on insulators can affect the safety of power transmission and transformation. Therefore, insulators in substations should be cleaned frequently. Common maintenance methods include water washing or manual cleaning. For high-positioned insulators, lifting vehicles are required as a medium for cleaning operations, which results in high difficulty and significant safety risks. The present application aims to address these problems.

At present, water washing is commonly used for cleaning insulators in substations. However, since insulators are generally ring-shaped and have many dead corners, it is difficult to achieve comprehensive cleaning using water washing alone. On the other hand, physical cleaning methods are often incomplete. Different types of contaminants on insulators cannot be effectively removed using a single brush, and due to the ring-shaped structure and numerous dead corners, a single brush cannot achieve satisfactory cleaning performance.

### SUMMARY

The purpose of this section is to summarize certain aspects of the embodiments of the present application and to briefly introduce some embodiments. Simplifications or omissions may be made in this section, as well as in the abstract and the title of the present application, to avoid obscuring their purposes; however, such simplifications or omissions shall not be used to limit the scope of the present application.

In view of the above, and in order to address the problem in the related art that dead corners of insulators are difficult to clean, the present application is proposed.

Accordingly, the object of the present application is to provide a multifunctional insulator cleaning device.

In order to solve the above technical problems, the present application provides the following technical solutions. The multifunctional insulator cleaning device, including:
a cleaning component including:
a driving assembly;
two transmission assemblies symmetrically and slidably provided at both ends of the driving assembly;
an abutment assembly symmetrically fixed to an inner of a corresponding transmission assembly; and
a cleaning assembly provided at the abutment assembly; where the cleaning assembly is inserted into the transmission assembly; the driving assembly is configured to drive the two transmission assemblies to operate; the two transmission assemblies are configured to drive the cleaning assembly to rotate; in response to that the two transmission assemblies move away from each other, the cleaning assembly is configured to disengage from the transmission assembly and the abutment assembly;
an adjustment component including a rotation assembly fixed to the transmission assembly and an adjustment assembly fixed to the driving assembly; and a triggering component including a support rod assembly fixed to the rotation assembly, a track assembly and a limiting assembly slidably provided at the support rod assembly, and a triggering assembly rotatably provided at the track assembly; the track assembly being connected to the adjustment component;
where the transmission assembly includes a semi-circular shell, a driving wheel and a driven wheel; the driving wheel and the driven wheel are rotatably provided at the semi-circular shell; the driving wheel is connected to the driven wheel by a transmission belt; the transmission belt is limited by the adjustment wheel; the driving wheel is provided with a through groove; the driven wheel is provided with a groove.

In an embodiment, the driving assembly includes a rotation driver, and two transmission rods fixed to both ends of the rotation driver; the transmission rods are matched with the through groove.

In an embodiment, the abutment assembly includes a mounting ring, and a rotation ring rotatably provided within the mounting ring; the rotation ring is provided with an abutment groove; the mounting ring is connected to the semi-circular shell.

In an embodiment, the cleaning assembly includes:
an abutment head provided at the abutment groove;
a main rod fixed to the abutment head; and
an insertion rod and a brush head, both the insertion rod and the brush head being fixed to the main rod, and the insertion rod being matched with the groove.

In an embodiment, the rotation assembly includes:
a first curved plate fixed to the rotation driver, where the first curved plate is provided with a mounting groove;
a first sliding block slidably provided at the first curved plate; and
a sliding rod fixed to the first curved plate, where the guide rod is provided with a flat surface.

In an embodiment, the adjustment assembly includes:
a second curved plate fixed to the semi-circular shell; the second curved plate being provided with a sliding groove;
a limiting block fixed to the second curved plate;
a second sliding block slidably provided at the second curved plate; the second sliding block being provided with an attachment surface;
a first rotation member fixed to the second sliding block;
a transmission plate fixed to the first rotation member; and
a second rotation member fixed to the transmission plate; the sliding groove being matched with the sliding rod.

In an embodiment, the support rod assembly includes:
an mounting block fixed to the first sliding block;
an inner rod fixed to the mounting block; the inner rod being provided with a limiting groove and a circular groove; and
a support rod fixed to the inner rod.

In an embodiment, the track assembly includes:
a driving tube slidably provided at the inner rod; the driving tube being provided with
a rotation groove and a track groove; and
a ring provided at the track groove; the driving tube being connected to a second rotation member.

In an embodiment, the triggering assembly includes an output tube rotatably provided within the rotation groove; the output tube is provided with a spiral groove and a clamping groove; the spiral groove is matched with the ring.

In an embodiment, the limiting assembly includes:
two pull rods, each of the two pull rods being provided with a reserved groove;
a semi-circular plate fixed to each of the two pull rods;
a tension spring jointly fixed within two reserved grooves; and
a clamping ring and a limiting ring fixed to each of the two pull rods;
where the pull rod is matched with the ring; the clamping ring is matched with the clamping groove; the limiting ring is matched with the limiting groove.

In the present application, the cleaning component enables effective cleaning of insulators while allowing rapid replacement of the cleaning assembly, thereby facilitating quick adaptation to different types of contaminants on the insulator. The adjustment component is configured to adjust the angle of the cleaning component, enabling more comprehensive cleaning of the insulator, and the triggering component enables quick control of the replacement process of the cleaning assembly.

### BRIEF DESCRIPTION OF THE DRAWINGS

To more clearly illustrate technical solutions in the embodiments of the present application or the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is an overall schematic diagram of the insulator cleaning device according to embodiment of the present application.

FIG. 2 is a partial structural schematic diagram of the insulator cleaning device according to an embodiment of the present application.

FIG. 3 is a structural schematic diagram of the cleaning component of the insulator cleaning device according to an embodiment of the present application.

FIG. 4 is a structural schematic diagram of the driving assembly of the insulator cleaning device according to an embodiment of the present application.

FIG. 5 is a structural schematic diagram of the transmission assembly of the insulator cleaning device according to an embodiment of the present application.

FIG. 6 is a structural schematic diagram of the abutment assembly of the insulator cleaning device according to an embodiment of the present application.

FIG. 7 is a structural schematic diagram of the cleaning assembly of the insulator cleaning device according to an embodiment of the present application.

FIG. 8 is a structural schematic diagram of the adjustment component of the insulator cleaning device according to an embodiment of the present application.

FIG. 9 is a schematic diagram of the rotation assembly of the insulator cleaning device according to an embodiment of the present application.

FIG. 10 is a schematic diagram of the adjustment assembly of the insulator cleaning device according to an embodiment of the present application.

FIG. 11 is a schematic diagram of the triggering component of the insulator cleaning device according to an embodiment of the present application.

FIG. 12 is a schematic diagram of the support rod assembly of the insulator cleaning device according to an embodiment of the present application.

FIG. 13 is a schematic diagram of the track assembly of the insulator cleaning device according to an embodiment of the present application.

FIG. 14 is a schematic diagram of the triggering assembly of the insulator cleaning device according to an embodiment of the present application.

FIG. 15 is a schematic diagram of the limiting assembly of the insulator cleaning device according to an embodiment of the present application.

### DETAILED DESCRIPTION OF THE EMBODIMENTS

In order to make the above objects, features, and advantages of the present invention more apparent and readily understood, specific embodiments of the present invention will be described in detail below with reference to the accompanying drawings.

In the following description, numerous specific details are set forth in order to provide a thorough understanding of the present application. However, the present application may be implemented in other ways different from those described herein. Those skilled in the art may make similar modifications or variations without departing from the spirit and scope of the present application. Therefore, the present application is not limited to the specific embodiments disclosed below.

Furthermore, as used herein, the term “one embodiment” or “an embodiment” means that a particular feature, structure, or characteristic described may be included in at least one embodiment of the present application. The appearances of the phrase “in one embodiment” in various places in this specification do not necessarily refer to the same embodiment, nor are they mutually exclusive or alternative embodiments.

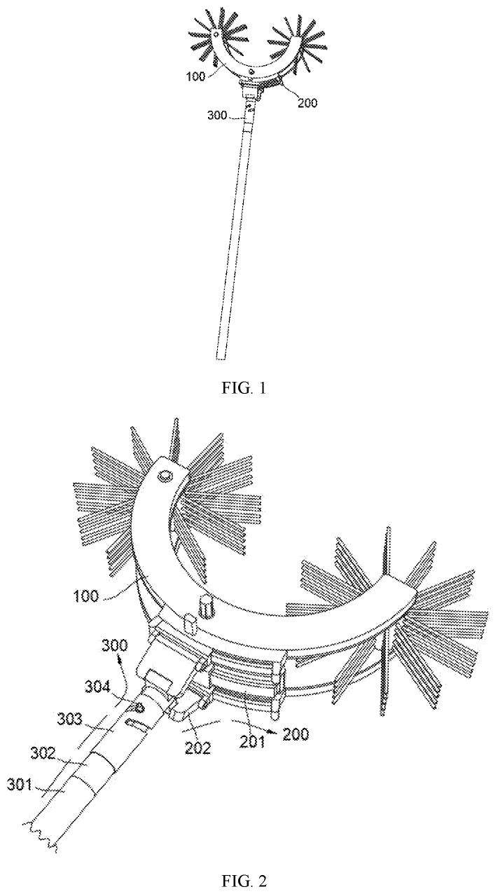

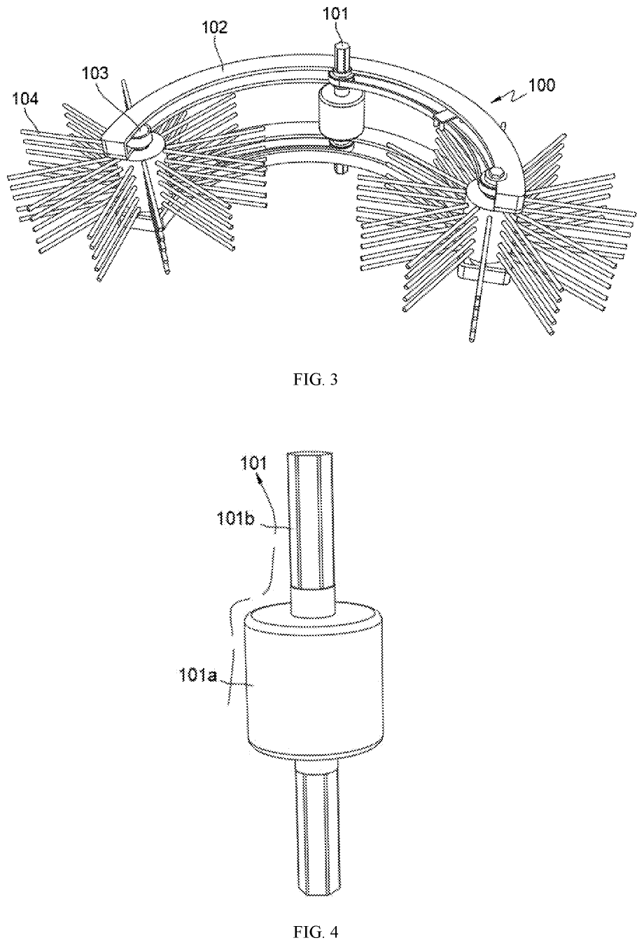

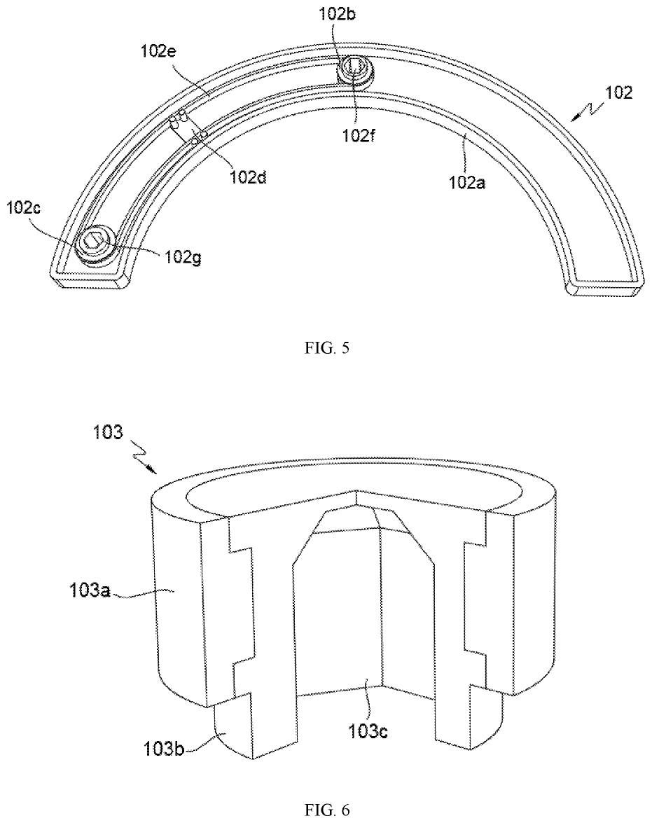

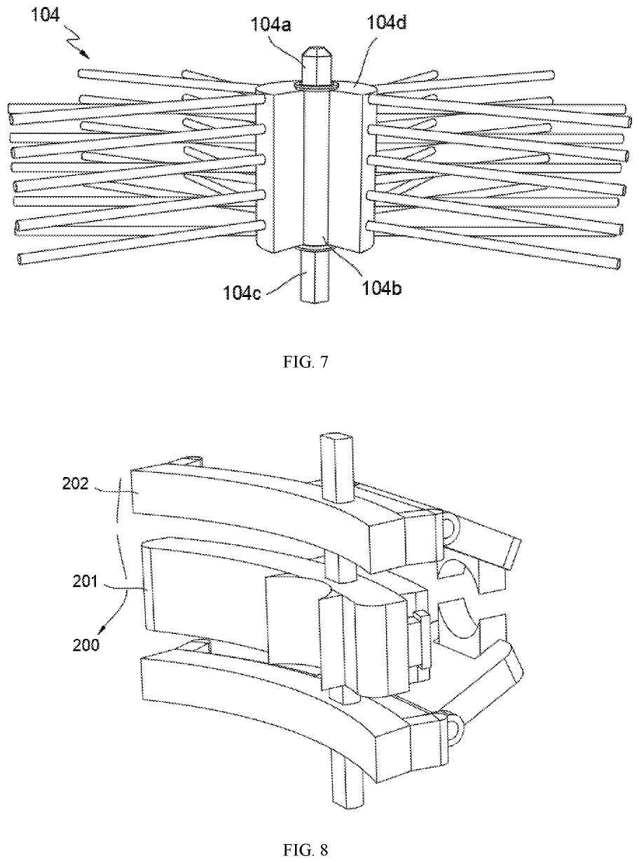

Referring to FIG. 1 to FIG. 7, a first embodiment of the present application is provided. This embodiment provides a multifunctional insulator cleaning device capable of cleaning both the overall surface of an insulator and its dead corners. The device includes a cleaning component 100, which includes a driving assembly 101 and two transmission assemblies 102 symmetrically and slidably disposed at two ends of the driving assembly 101. The device further includes abutment assemblies 103 symmetrically fixed within the respective transmission assemblies 102, a cleaning assembly 104 provided at the abutment assemblies 103. The cleaning assembly 104 is detachably insertable into the transmission assemblies 102. The driving assembly 101 is configured to drive the two transmission assemblies 102 to operate, and the two transmission assemblies 102 drive the cleaning assembly 104 to rotate. When the two transmission assemblies 102 move away from each other, the cleaning assembly 104 can be detached from the transmission assemblies 102 and the abutment assemblies 103. Accordingly, the driving assembly 101 drives the two transmission assemblies 102 to rotate simultaneously, and when the cleaning assembly 104 is inserted into the transmission assemblies 102 and the abutment assemblies 103, it can be driven to operate. Since the transmission assemblies 102 at both ends can be expanded or contracted, the cleaning assembly 104 can be quickly replaced.

The device further includes the adjustment component 200, which includes a rotation assembly 201 fixedly to the transmission assembly 102, and an adjustment assembly 202 fixedly to the driving assembly 101. There are two adjustment assemblies 202, one of which has a rotation assembly 201 at an opposite end. Both the rotation assemblies 201 and the adjustment assemblies 202 are symmetrically arranged. In this case, after the rotation assemblies 201 is adjusted, an opening of the cleaning component 100 can be positioned at different orientations, thereby enabling the cleaning assembly 104 to comprehensively clean the outer surface of an insulator. The adjustment assemblies 202 are configured to expand or contract the transmission assemblies 102 during adjustment, thereby controlling the spacing between the transmission assemblies 102 at the upper and lower ends.

The device further includes the triggering component 300, which includes a support rod assembly 301 fixed to the rotation assembly 201, a track assembly 302 and a limiting assembly 304 slidably provided at the support rod assembly 301, and a triggering assembly 303 rotatably provided at the track assembly 302. The track assembly 302 is connected to the adjustment assemblies 202. The support rod assembly 301 serves as a main holding rod. When the transmission assemblies 102 needs to be adjusted, the limiting assembly 304 can be released and the triggering assembly 303 can be rotated, such that the track assembly 302 drives the adjustment assemblies 202 to further drive the transmission assemblies 102 to be adjusted.

The device further includes the transmission assembly 102, which includes a semi-circular shell 102a, a driving wheel 102b rotatably provided at the semi-circular shell 102a, and a driven wheel 102c rotatably provided at the semi-circular shell 102a. The driving wheel 102b is located at a middle portion of an inner wall of the semi-circular shell 102a, and the driven wheel 102c is located at one end of the inner of the semi-circular shell 102a. The driving wheel 102b is connected to the driven wheel 102c by a transmission belt 102e, and the transmission belt 102e is limited by an adjustment wheel 102d. The adjustment wheel 102d is fixed within the semi-circular shell 102a between the driving wheel 102b and the driven wheel 102c. The driving wheel 102b is provided with a through groove 102f, and the driven wheel 102c is provided with a groove 102g.

During use, the driving assembly 101 drives the two transmission assemblies 102 to rotate simultaneously. When the cleaning assembly 104 is inserted into the transmission assemblies 102 and the abutment assemblies 103, the cleaning assembly 104 is driven to operate. Since the transmission assemblies 102 at both ends can be expanded or contracted, the cleaning assembly 104 can be quickly replaced. The rotation assemblies 201 and the adjustment assemblies 202 enable the cleaning component 100 to have two adjustable rotational orientations, thereby allowing comprehensive cleaning of the insulator. When improved cleaning performance or replacement of the cleaning assembly 104 is required, the limiting assembly 304 may be released and the triggering assembly 303 may be rotated, such that the track assembly 302 drives the adjustment assemblies 202 to further drive the transmission assemblies 102 to be adjusted.

In summary, the cleaning component 100 enables effective cleaning of insulators while allowing rapid replacement of the cleaning assembly 104, thereby facilitating quick adaptation to different types of contaminants on the insulator. The adjustment component 200 is configured to adjust the angle of the cleaning component 100, enabling more comprehensive cleaning of the insulator, and the triggering component 300 enables quick control of the replacement process of the cleaning assembly 104.

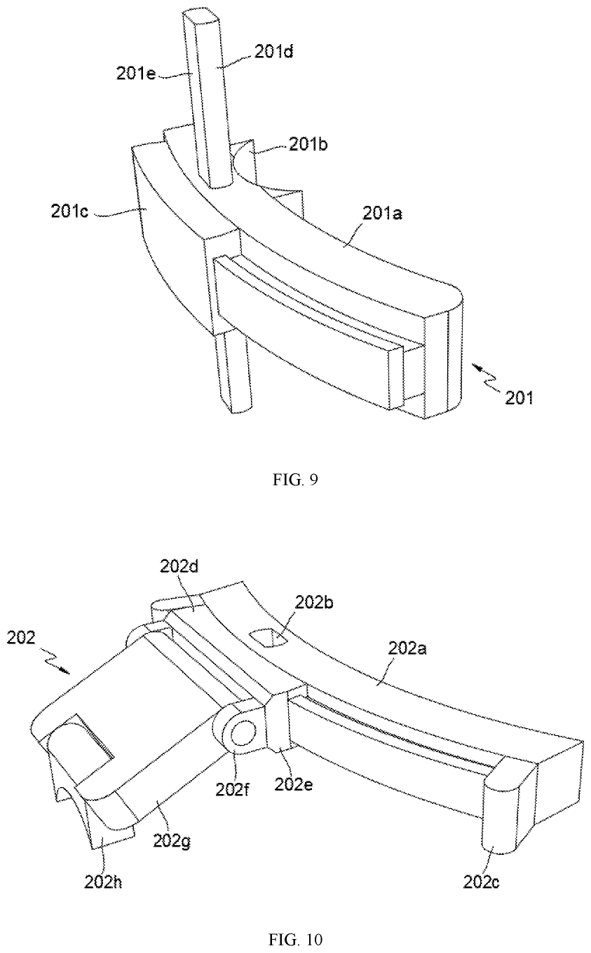

Referring to FIG. 1 to FIG. 10, a second embodiment of the present application is provided. Different from the previous embodiment, this embodiment provides an adjustment component 200 of the insulator cleaning device, which addresses the problem that annular insulators are difficult to clean. The driving assembly 101 includes a rotation driver 101a and two transmission rods 101b fixed to both ends of the rotation driver 101a. The rotation driver 101a is a dual-head motor. Each transmission rod 101b has a hexagonal shape, and the two transmission rods 101b are respectively provided at two driving ends of the rotation driver 101a. The transmission rods 101b match with the through grooves 102f, and outer ends of the transmission rods 101b are slidably provided within the corresponding through grooves 102f.

The abutment assembly 103 includes a mounting ring 103a and a rotation ring 103b rotatably provided within the mounting ring 103a. The rotation ring 103b is provided with an abutment groove 103c. The mounting ring 103a is connected to the semi-circular shell 102a and is located inside the semi-circular shell 102a at an end opposite to the driven wheel 102c.

Furthermore, the cleaning assembly 104 includes an abutment head 104a provided at the abutment groove 103c. The abutment head 104a is insertable into the abutment groove 103c for positioning, and is configured to apply force to the abutment groove 103c when rotating. The cleaning assembly 104 further includes a main rod 104b fixed to the abutment head 104a, as well as an insertion rod 104c and a brush head 104d fixed to the main rod 104b. The insertion rod 104c is located at an end of the main rod 104b opposite to the abutment head 104a, and the brush head 104d is provided at an outer wall of the main rod 104b. The insertion rod 104c matches with the groove 102g, and is insertable into the groove 102g for positioning.

Furthermore, the rotation assembly 201 includes a first curved plate 201a fixed to the rotation driver 101a. The first curved plate 201a is provided with a mounting groove 201b which is provided at an end of the inner side of the first curved plate 201a. The mounting groove 201b serves as a position where the first curved plate 201a is fixed to the rotation driver 101a. The rotation assembly 201 further includes a first sliding block 201c slidably provided at the first curved plate 201a. The first sliding block 201c is provided at an outer wall of the first curved plate 201a. The rotation assembly 201 further includes two sliding rods 201d fixed to the first curved plate 201a, Two sliding rods 201d are respectively provided at upper and lower ends of the first curved plate 201a. Each sliding rod 201d is provided with a flat surface 201e.

Furthermore, the adjustment assembly 202 includes second curved plates 202a fixed the semi-circular shell 102a. Two second curved plates 202a are provided, and are respectively provided at the outer wall of the semi-circular shell 102a corresponding to upper and lower ends of the first curved plate 201a. Each second curved plate 202a is provided with a sliding groove 202b and a limiting block 202c fixed to the second curved plate 202a. Each second curved plate 202a is provided with two limiting blocks 202c. Two limiting rings 202c are respectively provided at two ends of the outer wall of the second curved plate 202a. The adjustment assembly 202 further includes a second sliding block 202d slidably provided at the second curved plate 202a. The second sliding block 202d is provided at the outer wall of the second curved plate 202a between the two limiting blocks 202c. Each second sliding block 202d is provided with two attachment surfaces 202e. When the second sliding block 202d slides along the outer wall of the second curved plate 202a to one of the limiting blocks 202c, the attachment surface 202e abuts against the corresponding limiting block 202c. The adjustment assembly 202 further includes a first rotation member 202f fixed to the second sliding block 202d, the first rotation member 202f being located at an end of the second sliding block 202d away from the second curved plate 202a. The adjustment assembly 202 further includes a transmission plate 202g fixed to the first rotation member 202f, and a second rotation member 202h fixed to the transmission plate 202g. The sliding groove 202b matches with the sliding rod 201d. The sliding rod 201d is slidably provided in the sliding groove 202b and is limited by the flat surface 201e.

The remaining structures are the same as those in the first embodiment.

During use, when it is necessary to adjust an angle of the cleaning component 100, the support rod assembly 301 may be held to drive the cleaning component 100 and the adjustment component 200 to rotate with the mounting groove 201b serving as a top pivot. Due to the weight of the cleaning component 100, the second sliding block 202d moves to an end of the second curved plate 202a opposite to the mounting groove 201b. During this process, the rotation assembly 201 moves accordingly, such that an opening of the cleaning component 100 is inclined downward. In t his case, the cleaning assembly 104 located at an upper position can clean the end of the insulator provided at a side opposite to the operator, thereby improving cleaning effectiveness and enabling more comprehensive cleaning of the insulator. For resetting, it is only necessary to hold the support rod assembly 301 and rotate it by 180 degrees to restore the structure, at which point the opening of the cleaning component 100 is also reset, allowing normal cleaning operation to proceed.

In summary, the cleaning component 100 is capable of operating in two cleaning modes, thereby enhancing the ability to comprehensively clean the insulator and effectively addressing the difficulty of cleaning dead corners of the insulator.

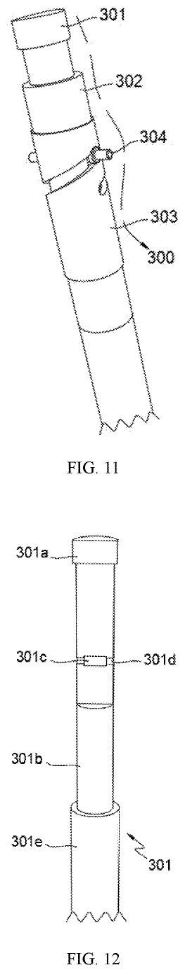

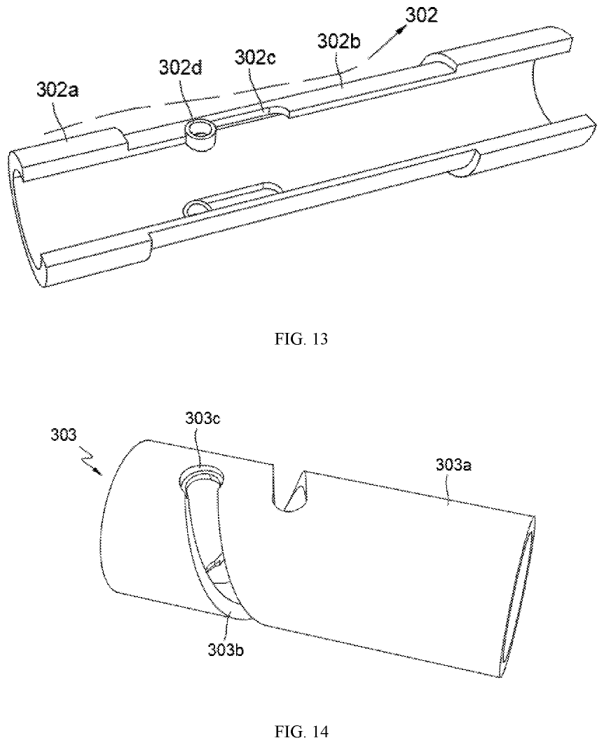

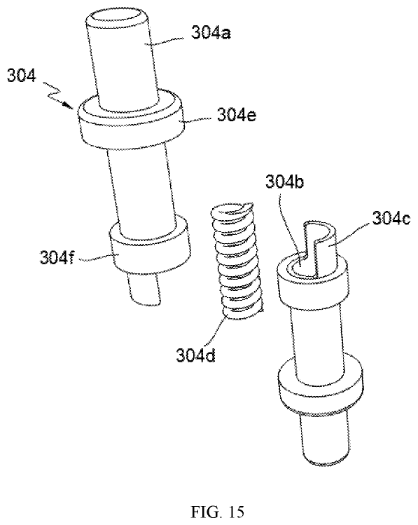

Referring to FIG. 1 to FIG. 15, a third embodiment of the present application is provided. Different from the previous embodiments, this embodiment provides a triggering component 300 of the insulator cleaning device, which addresses the problem that brush heads are inconvenient to replace. The device includes a support rod assembly 301, which includes a mounting block 301a fixed to the first sliding block 201c, the mounting block 301a being located at an end of the first sliding block 201c away from the first curved plate 201a. The device further includes an inner rod 301b fixed to the mounting block 301a, the inner rod 301b being located at an end of the mounting block 301a away from the first sliding block 201c. The device further includes an inner rod 301b provided with a limiting groove 301c and a circular groove 301d. The limiting groove 301c is located at a middle portion of the inner rod 301b. The two ends of the limiting groove 301c communicate with the outer wall of the inner rod 301b through the circular groove 301d. The device further includes a support rod 301e fixed to the inner rod 301b, the support rod 301e being located at an end of the inner rod 301b away from the mounting block 301a.

The track assembly 302 includes a driving tube 302a slidably provided at the inner rod 301b, and the driving tube 302a is provided at an outer wall of the inner rod 301b. The driving tube 302a is provided with a rotation groove 302b and a track groove 302c. The rotation groove 302b is provided at the outer wall of the driving tube 302a, and two symmetrically arranged track grooves 302c are formed within the rotation groove 302b. The track assembly 302 further includes a ring 302d disposed in the track groove 302c. Two rings 302d are provided. Each ring 302d is disposed within a corresponding track groove 302c. The driving tube 302a is connected to the second rotation members 202h. The rotation ends of two second rotation members 202h are fixed to the driving tube 302a.

Furthermore, the triggering assembly 303 includes an output tube 303a rotatably disposed in the rotation groove 302b. The output tube 303a is provided with a spiral groove 303b and a clamping groove 303c. The spiral groove 303b is a semi-circular spiral groove having a length equal to the length of the track grooves 302c. Two clamping grooves 303c are provided, and disposed at ends of the output tube 303a opposite to the circular grooves 301d. The spiral groove 303b matches with the ring 302d, and the ring 302d is configured to slide within the corresponding spiral groove 303b.

Further, the limiting assembly 304 includes two pull rods 304a. Each pull rod 304a is provided with a reserved groove 304b, the reserved grooves 304b being located at opposite ends of the two pull rods 304a. The limiting assembly 304 further includes a semi-circular plate 304c fixed to each pull rod 304a. The semi-circular plates 304c are also located at the opposite ends of the two pull rods 304a. The limiting assembly 304 further includes a tension spring 304d fixed to the two reserved grooves 304b. The limiting assembly 304 further includes a clamping ring 304e and a limiting ring 304f fixed to each pull rod 304a. The limiting ring 304f is provided at an outer wall of the pull rod 304a at a position corresponding to the reserved groove 304b, and the clamping ring 304e is provided at an end of the outer wall of the pull rod 304a away from the limiting ring 304f. The pull rod 304a matches with the ring 302d, and the portion of the pull rod 304a where the limiting ring 304f is opposite to the clamping ring 304e is located inside the ring 302d and the circular groove 301d. The clamping ring 304e matches with the clamping groove 303c. The limiting ring 304f matches with the limiting groove 301c. The limiting rings 304f is provided within the limiting groove 301c.

The remaining structures are the same as those in the second embodiment.

During use, the two pull rods 304a are pulled in opposite directions, such that the corresponding limiting ring 304f can move to two ends inside the limiting groove 301c. One of the pull rods 304a is then rotated so that opposing ends of the two semi-circular plates 304c abut against each other. In this case, the pull rod 304a drives the clamping ring 304e to disengage from the clamping groove 303c. The output tube 303a can then be rotated, causing the ring 302d located within the spiral groove 303b to move. The movement of the ring 302d is guided by the track groove 302c, thereby driving the driving tube 302a to move toward the mounting block 301a. This movement in turn drives the second rotation member 202h, the transmission plate 202g, and the first rotation member 202f to move. Therefore, the generated tension can drive the second sliding block 202d and the second curved plate 202a to move in opposite directions, thereby expanding the adjustment assemblies 202 at both ends. When resetting is required, the output tube 303a is rotated in an opposite direction to restore the subsequent structures. After resetting, the pull rod 304a is rotated, so that the two semi-circular plates 304c disengage from each other, and the tension spring 304d pulls the pull rod 304a back to the original position. Then the pull rod 304a drives the clamping ring 304e to be clamped in the clamping groove 303c.

In summary, after the adjustment assemblies 202 are expanded, the transmission assemblies 102 are correspondingly expanded, allowing the cleaning assembly 104 to be replaced. This operation process is convenient and efficient.

Importantly, it should be noted that the constructions and arrangements of the present application as shown in various embodiments are illustrative only. Although only a few embodiments have been described in detail herein, those skilled in the art will readily appreciate that many modifications are possible without materially departing from the novel teachings and advantages of the subject matter described herein (for example, variations in the size, dimensions, structures, shapes, and proportions of various elements, as well as parameter values, such as temperature, pressure, and the like, mounting arrangements, materials, colors, and orientations). For example, elements shown as integrally formed may be constructed of multiple parts or components, the positions of elements may be reversed or otherwise varied, and the nature, number, or positions of discrete elements may be altered or varied. Accordingly, all such modifications are intended to be included within the scope of the present application. In addition, the order or sequence of any process or method steps may be varied or re-sequenced according to alternative embodiments. In t he claims, any “means-plus-function” limitations are intended to cover the structures described herein for performing the recited functions, and not only structural equivalents but also equivalent structures. Further, other substitutions, modifications, changes, and omissions may be made in the design, operating conditions, and arrangements of the embodiments without departing from the scope of the present application. Accordingly, the present application is not limited to the specific embodiments disclosed, but extends to various modifications falling within the scope of the appended claims.

Moreover, for the sake of brevity in describing the embodiments, not all features of actual implementations are described (that is, those not relevant to the presently contemplated best mode of carrying out the present application, or those not necessary for implementing the present application).

It should be understood that, in the development of any actual implementation, as in any engineering or design project, numerous implementation decisions must be made. Such development efforts may be complex and time-consuming, but would nevertheless be a routine undertaking for those of ordinary skill in the art having the benefit of this disclosure, without undue experimentation.

It should be further noted that the above embodiments are provided for illustrating the technical solutions of the present application rather than limiting the same. Although the present application has been described in detail with reference to embodiments, those skilled in the art will understand that modifications or equivalent substitutions may be made to the technical solutions of the present application without departing from the spirit and scope of the present application, and all such modifications and substitutions shall fall within the scope of the present application.

What is claimed is:

1. A multifunctional insulator cleaning device, comprising:
a cleaning component comprising:
a driving assembly;
two transmission assemblies symmetrically and slidably provided at both ends of the driving assembly;
an abutment assembly symmetrically fixed to an inner of a corresponding transmission assembly; and
a cleaning assembly provided at the abutment assembly; wherein the cleaning assembly is inserted into the transmission assembly; the driving assembly is configured to drive the two transmission assemblies to operate; the two transmission assemblies are configured to drive the cleaning assembly to rotate; and in response to that the two transmission assemblies move away from each other, the cleaning assembly is configured to disengage from the transmission assembly and the abutment assembly;
an adjustment component comprising a rotation assembly fixed to the transmission assembly and an adjustment assembly fixed to the driving assembly; and
a triggering component comprising a support rod assembly fixed to the rotation assembly, a track assembly and a limiting assembly slidably provided at the support rod assembly, and a triggering assembly rotatably provided at the track assembly; and the track assembly being connected to the adjustment component;
wherein the transmission assembly comprises a semi-circular shell, a driving wheel and a driven wheel; the driving wheel and the driven wheel are rotatably provided at the semi-circular shell; the driving wheel is connected to the driven wheel by a transmission belt; the transmission belt is limited by the adjustment wheel; the driving wheel is provided with a through groove;
and the driven wheel is provided with a groove.

2. The insulator cleaning device according to claim 1, wherein the driving assembly comprises a rotation driver, and two transmission rods fixed to both ends of the rotation driver; and the transmission rods are matched with the through groove.

3. The insulator cleaning device according to claim 1, wherein the abutment assembly comprises a mounting ring, and a rotation ring rotatably is provided within the mounting ring; the rotation ring is provided with an abutment groove; and the mounting ring is connected to the semi-circular shell.

4. The insulator cleaning device according to claim 3, wherein the cleaning assembly comprises:
an abutment head provided at the abutment groove;
a main rod fixed to the abutment head; and
an insertion rod and a brush head, both the insertion rod and the brush head being fixed to the main rod, and the insertion rod being matched with the groove.

5. The insulator cleaning device according to claim 2, wherein the rotation assembly comprises:
a first curved plate fixed to the rotation driver, wherein the first curved plate is provided with a mounting groove;
a first sliding block slidably provided at the first curved plate; and
a sliding rod fixed to the first curved plate, wherein the guide rod is provided with a flat surface.

6. The insulator cleaning device according to claim 4, wherein the adjustment assembly comprises:
a second curved plate fixed to the semi-circular shell, the second curved plate being provided with a sliding groove, and the sliding groove being matched with a sliding rod;
a limiting block fixed to the second curved plate;
a second sliding block slidably provided at the second curved plate; the second sliding block being provided with an attachment surface;
a first rotation member fixed to the second sliding block;
a transmission plate fixed to the first rotation member; and
a second rotation member fixed to the transmission plate.

7. The insulator cleaning device according to claim 5, wherein the support rod assembly comprises:
an mounting block fixed to the first sliding block;
an inner rod fixed to the mounting block, the inner rod being provided with a limiting groove and a circular groove; and
a support rod fixed to the inner rod.

8. The insulator cleaning device according to claim 7, wherein the track assembly comprises:
a driving tube slidably provided at the inner rod, the driving tube being provided with a rotation groove and a track groove, and the driving tube being connected to a second rotation member; and
a ring provided at the track groove.

9. The insulator cleaning device according to claim 8, wherein the triggering assembly comprises an output tube rotatably provided within the rotation groove; the output tube is provided with a spiral groove and a clamping groove; and the spiral groove is matched with the ring.

10. The insulator cleaning device according to claim 8, wherein the limiting assembly comprises:
two pull rods, each of the two pull rods being provided with a reserved groove;
a semi-circular plate fixed to each of the two pull rods;
a tension spring jointly fixed within two reserved grooves; and
a clamping ring and a limiting ring fixed to each of the two pull rods;
wherein the pull rod is matched with the ring; the clamping ring is matched with the clamping groove; and the limiting ring is matched with the limiting groove.
